(19) United States
(12) Patent Application Publication
(10) Pub. No.: US 2018/0218176 A1
(43) Pub. Date: Aug. 2, 2018

(54) SYSTEM AND METHOD OF CREATING AN ASSET BASED AUTOMATED SECURE AGREEMENT

(71) Applicant: SALT Lending Holdings, Inc., Denver, CO (US)

(72) Inventors: Erik Voorhees, Denver, CO (US); Shawn Owen, Westminster, CO (US); Blake Cohen, Denver, CO (US); Benjamin Yablon, Denver, CO (US); Michael Mogren, Jensen Beach, FL (US); Caleb Slade, Denver, CO (US); Edward O'Brien, Louisville, KY (US); Raine Revere, Lakewood, CO (US)

(21) Appl. No.: 15/883,246

(22) Filed: Jan. 30, 2018

Related U.S. Application Data
(60) Provisional application No. 62/452,123, filed on Jan. 30, 2017.

(51) Int. Cl. G06F 21/64; H04L 9/32; G06Q 20/40

(52) U.S. Cl. CPC G06F 21/64; H04L 9/3213; H04L 2209/56; H04L 9/3297; H04L 2209/38; G06Q 20/401

(57) ABSTRACT

Disclosed is a system, a method and computer-readable medium for implementing a smart contract on a blockchain. The method includes creating, via a processor, a smart contract documenting a contractual relationship of at least two parties based on an exchange of an asset, monitoring an execution of the smart contract and a current value of the asset to yield a status, and managing the smart contract based on the status. The smart contract can be exited and unused gas returned based on an event occurring or a quorum parameter being met.

### PRIORITY

This application claims priority to U.S. Provisional Patent Application No. 62/452,123 filed on Jan. 30, 2017, which is herein incorporated by reference in its entirety.

### TECHNICAL FIELD

The present disclosure relates to implementing an automated secure agreement based on an exchange of an asset such as a digital asset.

### BACKGROUND

Digital assets, such as Bitcoin, are commonly utilized as an alternative form of currency for exchanging goods and services among various parties over a digital network. However, the use of such digital currencies are limited in a sense that a holder of such digital currencies cannot leverage the same (as collateral) in exchange for securing access to other forms of capital such as loans and lines of credit.

Furthermore, current manual platforms used in creating, documenting and managing agreements (and lending terms thereof) between two parties (e.g., a lender and a borrower) require resources (human resources often in the form of a third party to facilitate and ensure a proper execution of such agreement), which has been proven to be costly, inefficient, time consuming and susceptible to errors and security breach of critical data belong to the contractual parties.

### BRIEF DESCRIPTION OF THE DRAWINGS

The disclosure will be readily understood by the following detailed description in conjunction with the accompanying drawings in which:

FIG. 1 illustrates the basic computing components of a computing device according to an aspect of this disclosure;

FIG. 2 illustrates an environment, in which the system 100 may be utilized as a platform for creating a smart contract between at least two parties, according to an aspect of the present disclosure;

FIG. 3 illustrates a system for creating a digital asset based smart contract, according to an aspect of the present disclosure;

FIG. 4 illustrates a method of creating a digital asset based smart contract, according to an aspect of the present disclosure;

FIG. 5 illustrates a process of creating a Secure Automated Lending Terms smart contract of FIG. 3, according to an aspect of the disclosure; and

FIG. 6 illustrates a method implementing a multisignature smart contract.

### DESCRIPTION OF EXAMPLES

### Overview

As described above, current owners/holders of digital assets cannot leverage their holdings as collateral in securing access to capital (e.g., more traditional sources of currency). Furthermore, currently available manual platforms are costly, time consuming, inefficient and insecure. Given the issues raised above with respect to agreements between parties, what is needed is an improvement in currently available platforms to enable a more secure, less costly and more efficient platform through which assets such as digital assets or other assets may be used as a basis for various parties to enter into agreements for securing access to capital.

The approach disclosed herein addresses the described inefficiencies by providing an automated and secure platform/system through which interested entities (and/or individuals) may engage in requesting and/or offering access to capital in exchange for offering and/or accepting a digital asset (or any other asset including a non-digital asset) as collateral for securing the capital. In an example, the automated and secure platform replaces traditional third parties in the sense that the platform automatically creates a “smart contract” between the interested parties (e.g., a borrower and a creditor/lender), which enables a requesting party to secure a loan or a line of credit in exchange for offering the requesting party's asset as collateral. Through the smart contact, the platform/system automatically monitors the performance of all parties according to their rights and obligations as set in the contract and manages (and/or modifies) contract terms in response to the performance of all parties and/or fluctuations in the value of the underlying asset. In an example, the smart contract may also be referred to as a Secure Automated Lending Terms smart contract (SALT).

The use of the smart contract further addresses issues with respect to transparency and auditability through, for example, the unique recordation of each agreement in a bitcoin blockchain, or other blockchain technology, as will be described below.

In the present disclosure, the contract is in a sense built into the code, which means in one aspect that using blockchain technology and smart contracts, at least some steps that are performed by the code can be transparent and processes are secured by the laws of cryptography. Individuals would have great difficulty trying to forge data, erase data or add data inappropriately. The system also provides transparency in view of who owns the assets and their providence over time. Because of this new system, a new infrastructure has greater cyber security, and has greater overall security in terms of having to trust third parties or humans.

The code as it is contemplated herein is a manifestation of the intention of the parties to the smart contract. Applying a smart contract in such a manner reduces the amount of interpretation with respect to the contract by establishing that the code is the literal manifestation of the intention of the parties, and that there is no ambiguity.

A number of examples will be provided related to assets, digital assets, Bitcoins, Ethereum, or other digital currencies and digital assets. However, it is specifically noted that the concepts apply to any type of blockchain asset or traditional assets such as stock equities, bonds, commodities, real estate, insurance contracts, legal contracts, dollars, etc. With this technology, parties do not need to rely on manually prepared agreements and/or services of third party mediators (e.g., financial brokers, agents, lawyers) to secure an agreement for access to resources and capital, all of which are costly, time-consuming and/or susceptible to errors and data security breaches.

Parties may directly engage the smart contract platform/system described herein to secure access to capital in exchange for digital assets and rest assure that the underlying agreement is properly, efficiently and securely executed, monitored, and modified should any violation of any term of the agreement occur and completed. For example, a borrower may select requested terms of a loan through a platform 210 inside of his or her account. The letter would approve the request by selecting the terms that the appropriate unique passwords are generated from the borrower, lender, and an Oracle disclosed herein to confirm and establish the contract.

Based on examples described herein, the present system can utilize a multi-signature context, rather than using a single private key to create the smart contract between two or more parties. In a multi-signature context, the system requires multiple private keys before finalizing a contract and enabling a disbursement of the underlying loan in exchange for a digital asset. For example, the system can require each party to create a unique key, which will be embedded within the final secure document. For example, in a two-party agreement, the borrowing party can be instructed to create a unique key, the lending party can be instructed to create a unique key and the system itself creates a unique key, all of which together with the contract can then be embedded within a smart contract token before the contract is securely finalized. For example, the method can include populating the smart contract with the token, the first unique password, the second unique password and the third unique password to yield a secure smart contract. An oracle or service that provides a data feed to the contract could also provide a unique key as well.

In one or more examples, the system could require the majority of the keys (e.g., 2 out of 3 possible keys) to verify an agreement. The multi-signature arrangement removes a point of failure from the process and provides a safer transaction. This can apply just to the “oracle” disclosed herein and/or to other components.

### DESCRIPTION

Various examples will now be described more fully with reference to the accompanying drawings. Like elements on the drawings are labeled by like reference numerals. Any feature of any example can be mixed and matched with any feature of any other example.

Detailed illustrative examples are disclosed herein. However, specific structural and functional details disclosed herein are merely representative for purposes of describing examples. This disclosure may, however, be embodied in many alternate forms and should not be construed as limited to only the examples set forth herein.

Accordingly, while examples are capable of various modifications and alternative forms, the examples are shown by way of illustration in the drawings and will be described herein in detail. It should be understood, however, that there is no intent to limit examples to the particular forms disclosed. On the contrary, the examples are to cover all modifications, equivalents, and alternatives falling within the scope of this disclosure. Like numbers refer to like elements throughout the description of the figures.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular examples only and is not intended to be limiting. As used herein, the singular forms “a”, “an”, and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of examples. However, it will be understood by one of ordinary skill in the art that examples may be practiced without these specific details. For example, systems may be shown in block diagrams so as not to obscure the examples in unnecessary detail. In other instances, well-known processes, structures and techniques may be shown without unnecessary detail in order to avoid obscuring examples.

In the following description, illustrative examples will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs), computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium” or “computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, examples may be implemented by hardware, software, firmware, middleware, microcode, hardware description languages, or any combination thereof. When implemented in software, firmware, middleware, or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

The current computer infrastructure for managing a secured loans or secured agreements and the collateral put up for that transaction typically includes a server that stores a database of data associated with the loan. The database case store a copy of the loan agreement, data regarding the amount of the loan, the payoff amount, the payment history, data about the parties to the transaction and so forth. When data about the loan agreement changes, such as a change in an asset value is identified, then a user needs to manually access the database for that loan and make changes to the database. The parties to the loan also must trust the entity managing the database that the proper data will be entered and trusted.

Another computer component to the current loan computer infrastructure is a credit rating system. This is a separate system that receives information about the credit worthiness of individuals and also must be a trusted entity.

There are problems with the existing computer infrastructure for managing loans. First, entities like credit rating systems may not have rankings that accurately rate the credit worthiness of a borrower. Next, the parties to the transaction must trust the entity managing the loan as that entity owns the server that stores the database with data for managing the loan process. Privacy and security are also problems associated with the current system. There is no technical infrastructure for enabling a digital currency to be deployed as collateral either.

The present disclosure provides an improvement in computer technology by implementing several new technical features associated with a loan transaction. The technical improvements include the implementation of such components as a smart contract creator that can generate a blockchain-based smart contract that documents a contractual relationship of two or more parties based on an exchange of an asset, which can be cryptocurrency. The smart contract can also include a contract monitor that is configured to monitor the execution of the smart contract on the blockchain and a current value of the asset to yield a status. A smart contract manager can be implemented to then manage the smart contract on the blockchain according to the status.

While loan transactions are generally known, the present disclosure implements a novel and new technical approach to address some of the problems in the existing loan computer infrastructure. The introduction of these components represent a non-conventional combination of features that, when combined as disclosed herein, improve the functioning of computer systems with respect to loan management and also introduce the concept of blockchain based management of loan transactions and digital assets for representing collateral. New infrastructure, the blockchain network, is also added as a new component to management of loans and collateral.

The new computer components enable a trustless loan management process and include additional benefits not realized by the traditional loan management approach. It is noted that the concepts disclosed herein do not represent merely the implementation of a fundamental economic practice that long has been prevalent in our system of commerce. The use of the smart contract creator, the smart contract monitor, and the smart contract manager, and their functionality in connection with a blockchain network, are non-conventional components to loan processes and represent improvements to the prior computer systems used to manage loans.

In addition, rather than implementing a basic fundamental economic practice on a computer system, the present disclosure requires and improves the use of computers as tools for achieving additional benefits for loan management. For example, the use of the various components and the introduction of a blockchain-based network provide a new set of tools and functionality for managing a loan collateralized by a digital asset and that eliminates the trust requirement in traditional loan transactions and can make the process more efficient.

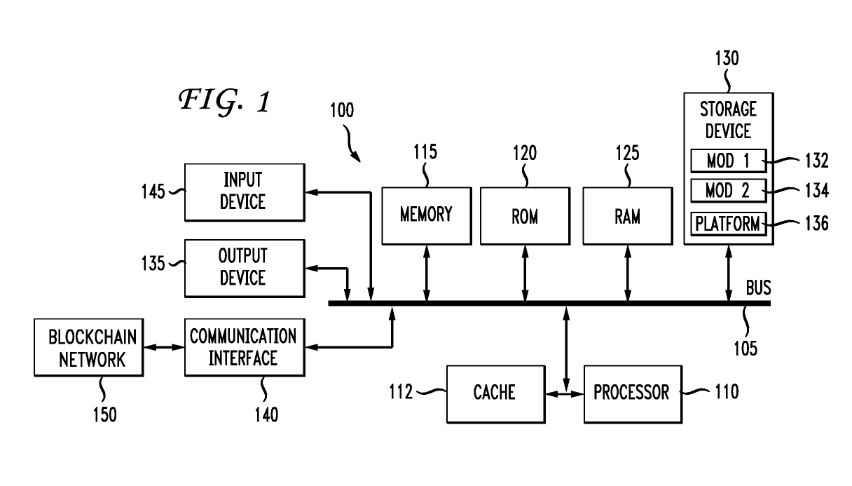

The disclosure now turns to FIG. 1 which illustrates the basic computing components of a computing device according to an aspect of this disclosure. With reference to FIG. 1, an exemplary system and/or computing device 100 includes a processing unit (CPU or processor) 110 and a system bus 105 that couples various system components including the system memory 115 such as read only memory (ROM) 120 and random access memory (RAM) 125 to the processor 110. The system 100 can include a cache 112 of high-speed memory connected directly with, in close proximity to, or integrated as part of the processor 110. The system 100 copies data from the memory 115, 120, and/or 125 and/or the storage device 130 to the cache 112 for quick access by the processor 110. In this way, the cache provides a performance boost that avoids processor 110 delays while waiting for data. These and other modules can control or be configured to control the processor 110 to perform various operations or actions. Other system memory 115 may be available for use as well. The memory 115 can include multiple different types of memory with different performance characteristics. It can be appreciated that the disclosure may operate on a computing device 100 with more than one processor 110 or on a group or cluster of computing devices networked together to provide greater processing capability. The processor 110 can include any general purpose processor and a hardware module or software module, such as module 1 132, module 2 134, and a lending platform programming 136 stored in storage device 130, configured to control the processor 110 as well as a special-purpose processor where software instructions are incorporated into the processor. The platform 136 represents the system or platform disclosed herein for creating and deploying smart contracts on a blockchain network 150. The processor 110 may be a self-contained computing system, containing multiple cores or processors, a bus, memory controller, cache, etc. A multi-core processor may be symmetric or asymmetric. The processor 110 can include multiple processors, such as a system having multiple, physically separate processors in different sockets, or a system having multiple processor cores on a single physical chip. Similarly, the processor 110 can include multiple distributed processors located in multiple separate computing devices, but working together such as via a communications network. Multiple processors or processor cores can share resources such as memory 115 or the cache 112, or can operate using independent resources. The processor 110 can include one or more of a state machine, an application specific integrated circuit (ASIC), or a programmable gate array (PGA) including a field PGA.

The system bus 105 may be any of several types of bus structures including a memory bus or memory controller, a peripheral bus, and a local bus using any of a variety of bus architectures. A basic input/output system (BIOS) stored in ROM 120 or the like, may provide the basic routine that helps to transfer information between elements within the computing device 100, such as during start-up. The computing device 100 further includes storage devices 130 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. The storage device 130 is connected to the system bus 105 by a drive interface. The drives and the associated computer-readable storage devices provide nonvolatile storage of computer-readable instructions, data structures, program modules and other data for the computing device 100. In one aspect, a hardware module that performs a particular function includes the software component stored in a tangible computer-readable storage device in connection with the necessary hardware components, such as the processor 110, bus 105, an output device such as a display 135, and so forth, to carry out a particular function. In another aspect, the system can use a processor and computer-readable storage device to store instructions which, when executed by the processor, cause the processor to perform operations, a method or other specific actions. The basic components and appropriate variations can be modified depending on the type of device, such as whether the computing device 100 is a small, handheld computing device, a desktop computer, or a computer server. When the processor 110 executes instructions to perform “operations”, the processor 110 can perform the operations directly and/or facilitate, direct, or cooperate with another device or component to perform the operations.

Although the example(s) described herein employs a storage device such as a hard disk 130, other types of computer-readable storage devices which can store data that are accessible by a computer, such as magnetic cassettes, flash memory cards, digital versatile disks (DVDs), cartridges, random access memories (RAMs) 125, read only memory (ROM) 120, a cable containing a bit stream and the like, may also be used in the exemplary operating environment. According to this disclosure, tangible computer-readable storage media, computer-readable storage devices, computer-readable storage media, and computer-readable memory devices, expressly exclude media such as transitory waves, energy, carrier signals, electromagnetic waves, and signals per se.

Optionally, to enable user interaction with the computing device 100, an input device 145 represents any number of input mechanisms, such as a microphone for speech, a touch-sensitive screen for gesture or graphical input, keyboard, mouse, motion input, speech, facial recognition, fingerprint recognition, multimodal input and so forth. An output device 135 can also be one or more of a number of output mechanisms known to those of skill in the art. In some instances, multimodal systems enable a user to provide multiple types of input to communicate with the computing device 100. The communications interface 140 generally governs and manages the user input and system output. There is no restriction on operating on any particular hardware arrangement and therefore the basic hardware depicted may easily be substituted for improved hardware or firmware arrangements as they are developed.

For clarity of explanation, the illustrative system example is presented as including individual functional blocks including functional blocks labeled as a “processor” or processor 110. The functions these blocks represent may be provided through the use of either shared or dedicated hardware, including, but not limited to, hardware capable of executing software and hardware, such as a processor 110, that is purpose-built to operate as an equivalent to software executing on a general purpose processor. For example the functions of one or more processors presented in FIG. 1 can be provided by a single shared processor or multiple processors. (Use of the term “processor” should not be construed to refer exclusively to hardware capable of executing software.) Illustrative examples may include microprocessor and/or digital signal processor (DSP) hardware, read-only memory (ROM) 120 for storing software performing the operations described below, and random access memory (RAM) 125 for storing results. Very large scale integration (VLSI) hardware examples, as well as custom VLSI circuitry in combination with a general purpose DSP circuit, may also be provided.

The logical operations of the various examples are implemented as: (1) a sequence of computer implemented steps, operations, or procedures running on a programmable circuit within a general use computer; (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited tangible computer-readable storage devices. Such logical operations can be implemented as modules configured to control the processor 110 to perform particular functions according to the programming of the module. For example, FIG. 1 illustrates three modules Mod1 132, Mod2 134 and Mod3 136 which are modules configured to control the processor 110. These modules may be stored on the storage device 130 and loaded into RAM 125 or memory 115 at runtime or may be stored in other computer-readable memory locations.

One or more parts of the example computing device 100, up to and including the entire computing device 100, can be virtualized. For example, a virtual processor can be a software object that executes according to a particular instruction set, even when a physical processor of the same type as the virtual processor is unavailable. A virtualization layer or a virtual “host” can enable virtualized components of one or more different computing devices or device types by translating virtualized operations to actual operations. Ultimately however, virtualized hardware of every type is implemented or executed by some underlying physical hardware. Thus, a virtualization compute layer can operate on top of a physical compute layer. The virtualization compute layer can include one or more of a virtual machine, an overlay network, a hypervisor, virtual switching, and any other virtualization application.

The processor 110 can include all types of processors disclosed herein, including a virtual processor. However, when referring to a virtual processor, the processor 110 includes the software components associated with executing the virtual processor in a virtualization layer and underlying hardware necessary to execute the virtualization layer. The system 100 can include a physical or virtual processor 110 that receive instructions stored in a computer-readable storage device, which cause the processor 110 to perform certain operations. When referring to a virtual processor 110, the system also includes the underlying physical hardware executing the virtual processor 110.

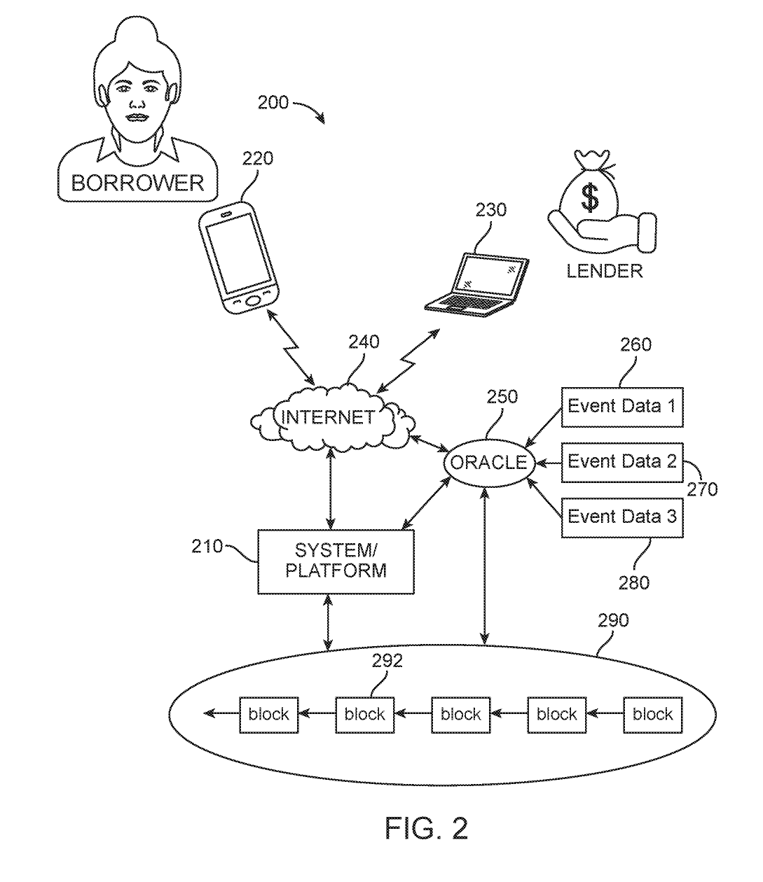

FIG. 2 illustrates an environment in which the system 100 may be utilized as a platform for creating a smart contract between at least two parties, according to an aspect of the present disclosure. The environment 200 includes a system 210, a first user device 220, a second user device 230 and an oracle 250. The first user device 220 can be, for example, used by a borrower who requests a loan. The second user device 230 can be, for example, a lender device that communicates with the system. The system or platform 210 can represent the system that interacts with the first user 220 and the second user 230 to finalize the terms of the smart contract and then implements the smart contract for execution on a blockchain network 290. The blockchain network 290 operates according to consensus rules applied by computers that have joined the blockchain network. The blockchain 290 is composed of blocks 292 that are added to the chain by miners or validators. The consensus rules of the blockchain 290 may include a proof-of-work mechanism by which miners compete to find a cryptographic nonce that satisfies a difficulty target set based on the total hash power of the network. Alternatively, or additionally, the consensus rules of the blockchain 290 can include a proof-of-stake under which validators confirm transactions. In the example illustrated in FIG. 2, the network nodes of the blockchain 290 will execute code thereon and the output of the code in part of the consensus reached by the blockchain network (e.g., all executing nodes must agree on the output of on-chain code). May of the operations disclosed herein can be performed by one or both of the system or platform 210 and the blockchain network 290 that is executing the smart contract.

The oracle 250 is a service that provides a data feed to the contract and could also provide a unique key as well. The oracle 250 can be an agent that finds and verifies real-world occurrences or events 270, 280, 290 and submits this information to one or more of the blockchain 290 and/or the system 210 to be used by the smart contracts. It can receive the data and format it or modify it in preparation for providing or submitting to the blockchain smart contract. Smart contracts contain value and only unlock that value if certain pre-defined conditions are met. When a particular value is reached, the smart contract changes its state and executes the programmatically predefined algorithms, automatically triggering an event on the blockchain. The primary task of oracles is to provide these values to the smart contract in a secure and trusted manner. Blockchains will not typically access data outside their network. The oracle 250 a data feed—provided by third party service—is designed for use by the smart contract. The oracle 250 will provide the external data and trigger smart contract executions when the pre-defined conditions as described herein are met. Such condition could be any data like weather temperature, successful payment, price fluctuations, etc.

In another aspect, the oracle 250 is part of multi-signature contract where, for example, the original trustees sign a contract for future release of funds only if certain conditions are met. Before any funds get released, the oracle 250 will sign the smart contract as well.

The system 210 or blockchain network 290 can include in individual component the same hardware component, or similar hardware components, as the system 100 described above with reference to FIG. 1. Accordingly and for sake of brevity, components and functionality of the system 200 will not be further described. As will be explained below, the system 200 may function to facilitate a creation and execution of a smart contract between at least two parties, according to which one party (e.g., the borrowing party) may gain access to resources such as capital and/or a line of credit offered by another party (e.g., the lending party), in exchange for the borrowing party providing a digital asset such as bitcoins or any cryptocurrency, or other asset, as collateral. The borrowing party may be associated with one device shown in FIG. 2 (e.g., the device 220) and the lending party may be associated with another device in FIG. 2 (e.g., the device 230). Hereinafter, the system 210 may also be referred to as the platform 210.

The first user device 220 and/or the second user device 230 may be any known or to be developed device, including but not limited to, a mobile device, a laptop, a desktop computer, a personal digital assistant (PDA), etc. The system can operate via applications on mobile devices, websites, other sites, via the Internet 240, or other network and so forth. Each of the first user device 220 and the second user device 230 may have a system that is the same as the system 100 described above, embedded therein and configured to store and execute computer-readable instructions to carry out respective functionalities, as is known in the art as well as the specific functionalities described in the present disclosure. The borrowing and lending parties, through their respective user devices, may communicate with each other and/or the system 210 via the Internet 240, according to any known or to be developed communication method. As will be described below, the nature of the blockchain network 290 is a distributed one, which translates into the network being run on a distributed network of hardware implementing a blockchain network 290. Accordingly, instead of a separate hardware entity running as the blockchain network 290, as shown in FIG. 2, the blockchain network 290 may be implemented on each of the user devices 220 and 230 in a decentralized fashion (as well as any other additional user device connected to the environment 200).

The system 210 may provide an interface (an application) on each of the first user device 220 and 230, through which the lending and borrowing parties may access the system 210 or blockchain network 290, offer terms, accepts terms, post digital assets, accept digital assets, receive and transmit messages regarding the execution of the smart contract, etc. Oracle 250 can also communicate data to the system 210 and/or the blockchain network 290 and receive information from the network 240.

While FIG. 2 illustrates devices 210, 220, 230, 250 and 290, examples are not limited thereto. Any number of parties, through their associated devices, may access the system 100 in order to create and manage a smart contract. Alternatively, parties to examples of smart contracts described herein are not limited to having a one-to-one contractual relationship. For example, two or more parties may join to create a single borrowing party, where each may contribute a portion of the digital asset required to secure a loan or a line of credit. Similarly, two or more parties may join to create a single lending party, where each may provide a portion of the loan or the line of credit, in exchange for a portion of the digital asset assigned thereto in proportion to each entity's contribution to the total amount of the loan or the line of credit. Accordingly, one-to-many, many-to-one and many-to-many contractual relationships may be established.

According to examples described herein, the system 210 and/or the blockchain network 290 utilize smart contracts written in Solidity, the Turing Complete language of Ethereum (Ethereum is an example of the system 210). Solidity is a high-level language that has a syntax similar to JavaScript that is designed to compile code for the Ethereum Virtual Machine. Through Solidity, the system 210 and/or the blockchain network 290 may create contracts for various applications such as contracts directed to securing a loan or a line of credit in exchange for digital asset(s). Other examples of smart contracts that may be created through Solidity include, but are not limited to, voting, crowd funding, blind auctions, multi-signature wallets, and more. Ethereum is a decentralized platform that runs smart contracts, which are autonomous applications that run as programmed with none or only a small possibility of downtime, censorship, fraud or third party interference. This is because the application runs on a custom built blockchain, which is a powerful shared global infrastructure that can move value around and represent ownership of property. Businesses can in this respect build their own custom platforms on top of the Ethereum public protocol. This infrastructure 290 enables developers to create markets, store registries of debts or promises, move funds in accordance with instructions given long in the past (like a will or a futures contract) and many other things that have not been invented yet, all without a middle man or counterparty and custodial risk. The present disclosure represents an innovative approach for implementation through such a smart contract on a platform like Ethereum.

The blockchain network 290 can use an open-source, cryptographically-secure, decentralized application platform of control that is built on blockchain technology. Blockchain technology creates a secure ledger that includes a record of the events or transactions that occur on the network. A blockchain ledger can be recorded in the memory of devices that comprise the network. The blockchain ledger forms a distributed database which can ensure that transactions on the network are never double-counted and are transparent, audible, and irrepudiable for the lifetime of the network (except for hard fork situations to roll the ledger back). The network platform can be turing-complete allowing for the creation and execution of distributed applications. The applications can be hosted on the network and be independent of individual nodes in the network once they are created which provides for the security and autonomy of the applications.

In the context of blockchains and crypto-currencies, smart contracts are: (1) pre-written logic (computer code); (2) stored and replicated on a distributed storage platform (e.g. a blockchain); (3) executed/run by a network of computers (usually the same ones running the blockchain); and (4) can result in ledger updates (crypto-currency payments, etc.).

In other words, smart contracts are little programs that execute conditional logic statements that are run and verified by many computers to ensure trustworthiness. If blockchains provide distributed trustworthy storage, then smart contracts provide distributed trustworthy calculations. There are three helpful ways to bring smart contracts into use for the present need. The first is to use or replace bank accounts with embedded instructions, the second is to replace legal-ese with computer code and the third is to provide an actual smart contract example.

With respect to bank accounts with embedded instructions, there are some elements of bank accounts that behave like smart contracts. Any given bank account has a balance. Every month, a user has an automated payment that deducts a fixed amount and sends it to the landlady. If there isn't enough money in the bank account, the payment fails, the user gets fined, and another workflow is triggered. There are instructions that the user can have set up which are associated with the account. This process is similar to what a smart contract can do, except that a smart contract running on a blockchain is managed by many parties rather than being controlled by a single one.

The next concept is replacing legal language with computer code. A smart contract is some code which automates the “if this happens, then do that” part of traditional contracts. Computer code should behave in expected ways and doesn't have the linguistic nuances of human languages. Code is better, as there are less potential points of contention. The code is replicated on many computers such that it is distributed/decentralized on a blockchain and run by those computers, who come to an agreement on the results of the code execution. The idea is that one can have a normal paper contract with all the “whereas” clauses that lawyers employ, and then a clause that points to a smart contract on a blockchain, saying “this is what we both agree to run and we will abide by the results of the code.”

Next is provided an actual smart contract example. The following is a non-limiting example of code that could be developed for a basic smart contract that is written for use on the Ethereum blockchain:

```
contract tokenRecipient { function receiveApproval(address _from, uint256 _value,
address_token, bytes _extraData); }
contract MyToken {
  /* Public variables of the token */
  string public standard = “Token 0.1”;
  string public name;
  string public symbol;
  uint8 public decimals;
  uint256 public totalSupply;
  /* This creates an array with all balances */
  mapping (address => uint256) public balanceOf;
  mapping (address => mapping (address => uint256)) public allowance;
  /* This generates a public event on the blockchain that will notify clients */
  event Transfer(address indexed from, address indexed to, uint256 value);
  /* Initializes contract with initial supply tokens to the creator of the contract */
  function MyToken(
    uint256 initialSupply,
    string tokenName,
    uint8 decimalUnits,
    string tokenSymbol
    ) {
```

| | |
|---|---|
| balanceOf[msg.sender] = initialSupply; | // Give the creator all initial tokens |
| totalSupply = initialSupply; | // Update total supply |
| name = tokenName; | // Set the name for display purposes |
| symbol = tokenSymbol; | // Set the symbol for display purposes |
| decimals = decimalUnits; | // Amount of decimals for display purposes |
| msg.sender.send(msg.value); | // Send back any ether sent accidentally |
| } | |
| /* Send coins */ | |

```
  function transfer(address _to, uint256 _value) {
    if (balanceOf[msg.sender] < _value) throw; // Check if the sender has enough
    if (balanceOf[_to] + _value < balanceOf[_to]) throw; // Check for overflows
```

| | |
|---|---|
| balanceOf[msg.sender] −= _value; | // Subtract from the sender |
| balanceOf[_to] += _value; | // Add the same to the recipient |
| Transfer(msg.sender, _to, _value); | // Notify anyone listening that this transfer |
| took place | |
| } | |

```
  /* Allow another contract to spend some tokens in your behalf */
  function approve(address _spender, uint256 _value)
    returns (bool success) {
    allowance[msg.sender][_spender] = _value;
    return true;
  }
  /* Approve and then comunicate the approved contract in a single tx */
  function approveAndCall(address _spender, uint256 _value, bytes _extraData)
    returns (bool success) {
    tokenRecipient spender = tokenRecipient(_spender);
    if (approve(_spender, _value)) {
      spender.receiveApproval(msg.sender, _value, this, _extraData);
      return true;
    }
  }
  /* A contract attempts to get the coins */
  function transferFrom(address _from, address _to, uint256 _value) returns (bool success) {
```

| | |
|---|---|
| if (balanceOf[_from] < _value) throw; | // Check if the sender has enough |

```
    if (balanceOf[_to] + _value < balanceOf[_to]) throw; // Check for overflows
    if (_value > allowance[_from][msg.sender]) throw; // Check allowance
```

| | |
|---|---|
| balanceOf[_from] −= _value; | // Subtract from the sender |
| balanceOf[_to] += _value; | // Add the same to the recipient |

```
    allowance[_from][msg.sender] −= _value;
    Transfer(_from, _to, _value);
    return true;
  }
  /* This unnamed function is called whenever someone tries to send ether to it */
  function ( ) {
    throw; // Prevents accidental sending of ether
  }
}
```

Ethereum.org explains what the above code does. In summary, the smart contract executed above generates 10 thousand tokens to the creator (e.g., the lending party associated with the user device 230 shown in FIG. 2) of the contract, and then allows anyone (e.g., the borrowing party associated with the user device 220 shown in FIG. 2) with enough balance to accept it and be bound by it. These tokens are the minimum tradeable unit and cannot be subdivided, but for the final users could be presented as a 100 units subdividable by 100 subunits, so owning a single token would represent having 0.01% of the total.

The above code and explanation is different from automated banking payments through its new kind of control. A user's bank is the ultimate guardian of their bank account. The bank has complete control, and can arbitrarily add money to the account or subtract it. In a correctly set-up blockchain ecosystem, there should be no single source of control. The distributed layout with consensus mechanisms mean that multiple parties are constantly checking and re-checking and updating the ledgers, and anything that doesn't conform to pre-agreed rules is rejected by other participants. Thus, the principles disclosed herein illustrate the new use of a blockchain network as a tool for managing contracts between individuals.

Another answer to what is different from automated banking accounts is code. With the bank account, there is some logic creating transactions on a monthly basis. That code sits on one computer and is executed by one party (the bank). There are internal controls and reconciliations, but there is no external validation. With smart contracts running on a blockchain, the logic is run in parallel on all the participating computers, and the results are compared by all participants. Participants only change their own version of the ledger if they agree with the results. No one can cheat a blockchain, in theory. A further answer is transparency. For all participants/parties in a blockchain ecosystem to run the same code, each verifying the other, the logic of the smart contract must be visible to all. This means any party can look into a smart contract, and if acceptable, the party may use it. Otherwise, the party does not utilize the smart contract. There may be smart contracts for general usage, and also very specific smart contracts such as the smart contract disclosed herein. The transparency is both a pro and a con. It is useful to all stakeholders of the contract to agree on what happens; on the other hand it is not just the stakeholders that can see what happens—everyone on the network can see. Privacy in blockchain is a contentious issue. There are solutions to the privacy-vs.-validation tension being discussed, some using zero-knowledge proofs.

Flexibility is also an answer to the question. The logic that a user can run within their bank account is limited to recurring payments, and maybe some other basic things. A user can't, for example, automate a payment from their salary account to their savings account every day it is sunny, then have it all sent back when there is a storm (the ‘saving up for a rainy day” smart contract). A so-called “Turing complete” smart contract can do anything that a normal computer can do, though the blockchain version will run much more slowly and be more expensive to run than on a regular computer (depending on the set-up of the blockchain), because ultimately, the user needs to pay for all computers on the network to run the code in parallel. With the smart contract, however, extra functionality can be provided wherein an oracle or other trusted source of data could feed that data to the smart contract wherein the user could establish a rule that every day it is sunny, a payment is made.

Smart contracts are useful when there are multiple parties, who may not trust each other fully, each comparing their version of events with each other. For example, when two banks do a complex derivative trade with each other that does not go through a clearing house, it is called an “Over The Counter” or OTC trade. These are agreements between the two banks, without third party validation. These trades are usually bets—i.e. variations of “if this happens before the end of the year then you pay me, else I pay you”. Both parties have a copy of the original trade documents (the terms and conditions of the trade), and they both have a view on the external dependencies of the trade. They should both therefore agree on the outcome of the trade i.e. who wins the bet. However, agreement is not guaranteed.

A mismatch or “break” can occur in the dependencies, where parties don't agree on the outcome of the trade, due to a number of things. For example, problems can include: (1) A mutual misunderstanding of the initial trade terms; (2) Confusion due to multiple copies of the original trade terms (usually there is back-and-forth on the wording of the documents, with in-house lawyers on both sides trying to protect their interests); or (3) A disagreement with what actually happened in the external dependencies.

With a smart contract, there is only one set of trade terms, written in computer code, which is more precise than a contract written in legal terms, and agreed upon up-front. The external dependencies (price of oil, share price of Apple, etc.) can be fed in via a mutually agreed feed. The uniquely implemented blockchain-based oracle (which is a source for current pricing or valuation information) 250 can be used as the data-feed in the present application. All that is exchanged is a contract that binds each party to pay one another based on the change in value of the underlying assets as recorded by some agreed upon external data, like a benchmark, price feed, or in this case, the multi-validator oracle. The oracle (which can be a multi-validator oracle) 250 can be an ensemble of blockchain-based smart-contracts and a set of JavaScript-based applications that enable the validation and authentication of data sourced from the public APIs of any website in the world. This data is then pushed to the blockchain-based smart-contract called the oracle (or any other name with similar functionality). The oracle 250 is used to provide information to decentralized applications. More specifically, the multi-validator oracle can provide a data feed to the smart contract. For example, the oracle 250 can monitor the loan and watch for required activities by one or more parties based on time windows in which the activities must occur. If the required activities by both parties do not occur as stated in the smart contract, the oracle 250 can follow a series of actions depending on each situation to correct the loan terms. Under this automated process, once all the loan terms have been completed and after the set timeframe, the contract can be permanently retired. For example, once loan terms and duration have been completed and are expired, the smart contract or token can be filed for permanent records and are no longer editable.

The contract will live on a blockchain, and run when an event happens or when the contract expires. The contract payout, if any, can be stored in the smart contract itself. For example, data associated with a cryptocurrency or a data packet of instructions that can be sent to an escrow service and be used to automatically implement payment. This is potentially cleaner than the existing process. However, there remain privacy issues with other blockchain participants having read-access to this contract and being able to see the terms of a bet between two of their competitors. Also, a lot of trades in financial services are currently done on credit and margined or collateralized; the necessity to pre-fund the total payout with the full value of the potential payout, in the currency/asset of the payout may not be attractive.

Current smart contract offerings are described next. The existing blockchains (of which there are many—Bitcoin, Ethereum, etc.) have varying degrees of effectiveness in running smart contracts. Bitcoin's platform is great for processing bitcoin transactions. An example of what is possible in bitcoin is logic requiring multiple signatories to sign a transaction before a payment is made, like needing two signatories in a check.

Furthermore, sidechains (i.e. blockchains connected to Bitcoin's main blockchain) could enable smart contract functionality by having different blockchains running in parallel to Bitcoin. These sidechains can be programmed with an ability to jump value between Bitcoin's main chain and the side chains, such that side chains could be used to execute logic.

NXT is a public blockchain platform which includes a selection of smart contracts that are currently live. However it is not Turing Complete, meaning that a person cannot code up anything desired. Instead, the user must use the existing templates. Ethereum, introduced above, is a public blockchain platform which is currently the most advanced smart contract enabled blockchain. With a “Turing Complete” coding system, theoretically a user can put any logic into an Ethereum smart contract, and it will be run by the whole network. There are mechanisms in place to prevent abuse, and users need to pay for compute power by passing in “ETH” tokens, which act as payment for the miners who run the code.

There are some questions and challenges with respect to the structure described above. Decentralization is expensive. The more computers that run code, the more expensive things get for the end users. The decentralization does not come for free. If one is using a system that has 10,000 computers running the user's code, somehow those compute costs need to be paid: the computer operators are not doing this for free. In a public network, the users necessarily end up paying to run all the machines on the network. Having every computer (“node”) in a system stores data (e.g. a copy of the blockchain, or a portion of the blockchain corresponding to specific assets/portfolios) and then running the smart contract code embedded within the blockchain is a lot more expensive than having one or two participants run the code on individual computers. Currently, nodes have to compute everything even if they are not attempting to mine the block, because the only way to validate a block is to run the code and compare the answers to the mined block.

Costs paid to execute a smart contract according to consensus rules may increase with the complexity of the contract. In other words, as a smart contract performs more operations that the ledger maintainers have to execute to validate the consensus rules, the cost of paying the ledger maintainers increases. Smart contracts that can accomplish a task in fewer steps (e.g., fewer on-chain calculations, “firing” fewer events, etc.) will therefore be cheaper for users of the decentralized consensus network (whom usually pay the costs to the maintainers of the shared ledger). Even in scenarios where a smart contract “pays its own gas,” the costs of fewer on chain events will be lower than more on chain events.

“Gas” is the internal pricing for running a transaction or contract in Ethereum. It can have a specific price, such as 1/100,000 of an Ether. The purpose of a “gas” value to decouple the unit of Ether (ETH) and its market value from the unit to measure computational use (gas). Thus, a miner can decide to increase or decrease the use of gas according to its needs, while if need be, the price of gas can be increased or decreased accordingly, avoiding a situation in which an increase in the price of ETH would cause the need to change all gas prices. This is also a response to the discussion in bitcoin about fees structure.

The gas system is not very different from the use of Kw for measuring electricity home use. One difference from the actual energy market is that the originator of the transaction sets the price of gas, to which the miner can or not accept, this causes an emergence of a market around gas. One can see the evolution of the price of gas here on available websites that track the gas price.

With Ethereum there is a blocksize limit too—so the individual is paying for premium space in the next block just like with Bitcoin. Bitcoin miners prioritize transactions with the highest mining fees. The same is true of Ethereum where miners are free to ignore transactions whose gas price limit is too low.

The gas price per transaction or contract is set up to deal with the Turing Complete nature of Ethereum and its EVM (Ethereum Virtual Machine Code)—the idea being to limit infinite loops. So for example 10 Szabo, or 0.00001 Ether or 1 Gas can execute a line of code or some command. If there is not enough Ether in the account to perform the transaction or message then it is considered invalid. The idea is to stop denial of service attacks from infinite loops, encourage efficiency in the code—and to make an attacker pay for the resources they use, from bandwidth through to CPU calculations through to storage.

The more complex the commands a user wishes to execute, the more gas (and Ether) they have to pay. For example if A wants to send B 1 Ether unit—there would be a total cost of 1.00001 Ether to be paid by A. However if A wanted to form a contract with B depending on the future price of Ether, there would be more lines of code executable and more of an onus or energy consumption placed on the distributed Ether network—and therefore A would have to pay more than the 1 Gas done in the transaction.

Some computational steps cost more than others as well either because they are computationally expensive or because they increase the amount of data that has to be stored in the state. The following paragraph provides an example list of operations in the Ethereum Virtual Code and their costs in gas.

| Operation | Gas | |
|---|---|---|
| name | Cost | Function |
| step | 1 | Default amount of gas to pay for an execution cycle. |
| stop | 0 | Nothing paid for the SUICIDE operation. |
| sha3 | 20 | Paid for a SHA3 operation. |
| sload | 20 | Paid for a SLOAD operation. |
| sstore | 100 | Paid for a normal SSTORE operation |
| | | (doubled or waived sometimes). |
| balance | 20 | Paid for a BALANCE operation |
| create | 100 | Paid for a CREATE operation |
| call | 20 | Paid for a CALL operation. |
| memory | 1 | Paid for every additional word when expanding |
| | | memory |
| txdata | 5 | Paid for every byte of data or code for a transaction |
| transaction | 500 | Paid for every transaction |

The gas price limit is fixed at present to provide for a stable launch of Ethereum but will be allowed to free float according to the demand and the amount of total gas per block will be increased gradually to encourage the stability of the Ethereum network.

If aspects of the system 200 include multisignature encumbrances on funds held in a smart contract on the blockchain 290, the way the smart contract handles signatures will determine how expensive the contract is to run. In one implementation, multisignature functionality may be included in a smart contract from which a main contract inherits. The main contract may include an array of loans, a unique loan in the array being associated with each lending agreement between the borrower and the lender. The main contract may call multisignature operations or functions from the inherited multisignature contract for any of the loans in the array.

One way to implement an inheritable multisignature contract is to maintain an array or list, each element in the list being a multisignature “wallet” subject to a set of encumbrances. Some possible encumbrances include a quorum needed to move funds, a total number of possible signers, particular wallet addresses on the blockchain 290 that are permitted to sign. These encumbrances may be recorded on the blockchain 290 when a new multisignature wallet is instantiated. The following example code may be used to add a new multisignature wallet to a list of multisignature wallets with encumbrances defined by the caller of the function. This code could be called by a main contract, for example, to initialize a new 2-of-3 multisignature wallet wherein funds could only be moved if two of the lender, borrower, and oracle sign the wallet.

Here is the example code:

```
function addMultiSig(uint _quorum, address[ ] _signers)
internal {
    //quorum must be at least 1 (used to determine existence)
    require (_quorum > 0);
    // autoincrement
    uint index = multisigs.length;
    // create new multisig
    multisigs.push (MultiSigData(_quorum, _signers, false));
// log
MultiSigAdded(index, _quorum, _signers);
}
```

The multisignature contract executing on the blockchain 290 may handle requests for new signatures in a way that minimizes gas costs. One way smart contracts can spend gas is upon the “firing” of events. Events may write data to the chain (e.g., that a particular signer has signed a multisignature wallet, updating the status of a multisignature wallet, initializing a new wallet, etc.) to provide hooks for monitoring by a user interface (e.g., a web interface that shows users the status of a multisignature wallet, a decentralized interface, etc.).

Each multisignature wallet may include a flag indicating whether a quorum of signatures has been reached. The flag may be set as an event and written to the chain such that a copy of the shared ledger will show a quorum has been reached. If the quorum flag is set to complete, and another party attempts to sign (e.g., a fourth signature in a 3-of-4 multisignature encumbrance), then the smart contract may return immediately without firing events (and thus consuming gas) because it would be superfluous to add a fourth signature to the 3-of-4 multisig encumbrance. Setting a completed flag also improves gas efficiency due to avoiding recalculating whether a quorum has been reached each time a function on the multisignature wallet is called.

A multisignature smart contract may record which of the parties has signed a multisignature wallet. If a party who has already signed the wallet once attempts to sign again, the smart contract may call the revert( ) function to stop execution and return all unused gas to the signer. Example source code for an inheritable multisignature smart contract with completed flag and signing function are as follows:

```
Struct MultiSigData {
    // the minimum number of signatures required to execute
    /// must be at least 1; used to determine existence within multigs
    mapping uint quorum;
    // the addresses that can sign
    address[ ] signers;
    // the signatures from signers
    mapping (address => bool) signatures;
    // record when a multisig is MultiSigcompleted to avoid recalculating
    every time bool complete;
    }
    function signAs (uint index, address signer) internal {
        //do not allow signer to sign more than once
        If (multisigs[index].signatures[signer]) revert ( );
        // record the new signature
        multisigs[index].signatures[signer] = true;
        // if already MultiSigcompleted, return immediately without
        firing events
        If (multisigs[index].completed) return;
        // log
        MultiSigSigned (index, signer);
        // check for completion
        If (isCompleteCheck(index)) {
            multisigs[index].completed = true;
            MultiSigCompleted (index);
        }
    }
```

It is typically good enough to have the code written on a blockchain so that parties can view the terms and functions carried out by the smart contract they created by their arrangement. The code can be run privately and thus not publicly viewable. In one aspect, the very parties to the transaction can manage or control the blockchain network upon which the smart contract executes. This would save on compute costs, but increase risk because only the transaction parties would be verifying the transaction/contract action (whereas normal blockchain interactions are verified by anonymous servers). For example, costs can be reduced as transactions in a private blockchain only need validation from the members themselves, thus removing the need for anonymous miners who have to expend lots of electricity. Thus, the blockchain network 290 can either be a public and transparent entity or a privately managed entity that it used for execution of the smart contract.

With these principles in mind, this disclosure next addresses the use of smart contracts, with smart contract being a specific example thereof, to enable an efficient and secure creation and execution of a contractual relationship between a borrowing entity and a lending entity so that the borrowing entity may gain access to a loan or a line of credit offered by the lending entity in exchange for providing the borrowing entity's asset as collateral to the lending party.

Typically, parties to a contract like optionality. In many contracts, clauses are written into things on purpose to create a channel for arbitration. For example in a flat rental agreement, wear-and-tear from tenants is acceptable, but major damage needs to be repaired. How does code define these things? Force majeure is present in many contracts to allow for wiggle-room for the parties involved. In a smart contract environment, how does one party claim a force majeure event without abusing it or referring to a human arbitrator? These issues can be worked out through smart contracts. Ultimately, shared ledgers will have a role to play in removing the need for trust among multi-party agreements. Smart contracts make sense for all parties by reducing operational risk, and can be thought of as automated trustworthy workflow between parties without a central specific coordinator.

The contract terms are agreed upon by both parties in the contract along with the specifics of the variable terms are time stamped into the blockchain network for permanent record. All loan information is stored in a token (the contract) is uniquely assigned to the loan. Each loan has a unique contract that is transferable. In other words, there could be a market between users in which the smart contract can be bought or sold. The smart contracts are created generically with all open blank fields for loan terms and data, and then become unique with the specifics of each loan are signed and recorded. Thus, included in the concepts disclosed herein, would be various user interfaces which could be presented to users with open blank fields for data about loan terms, assets, digital assets, and so forth. Users would then fill in the specific information associated with the respective contract such that all of the specific information is stored within the token or contract that is uniquely assigned to the loan. The contracts become unique with the specifics of each loan are signed and recorded. The contract can be multisignature contracts as well that require multiple signatures for confirmation of events. It is noted that any graphical interface, or speech or other interface is considered as part of this disclosure. Therefore, any functionality that is described, or variations thereof, can be implemented or shown through a user interface that can include graphics, selectable objects, input fields, speech input, multimodal input, facial recognition, graffiti input, and so forth. Any hardware component, touch-sensitive display screen, buttons, objects, microphones, and other components necessary to implement the user interface are included within this disclosure.

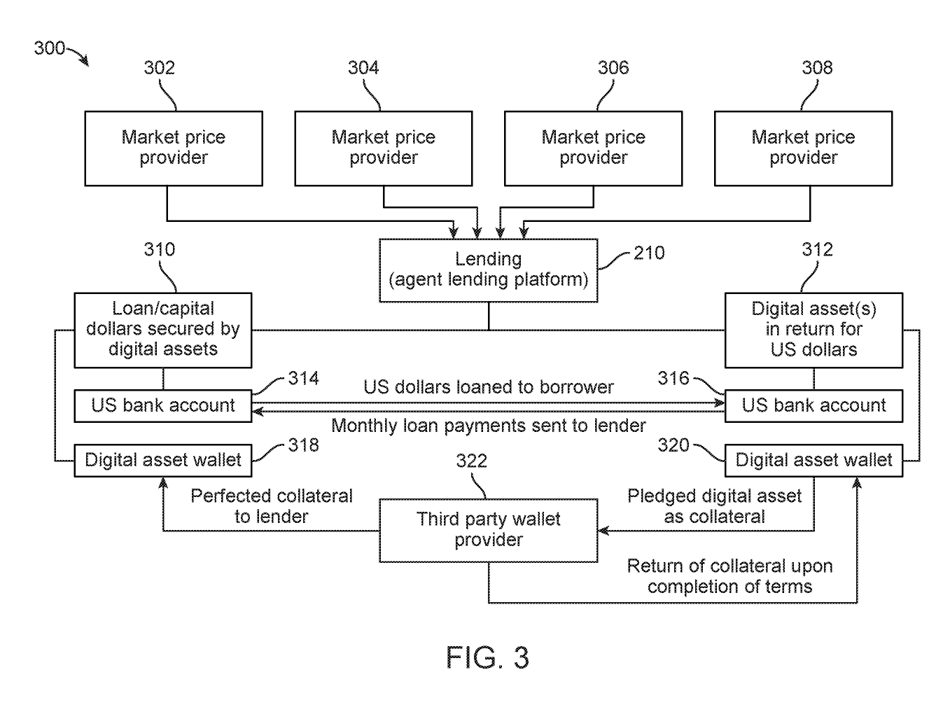

FIG. 3 illustrates a system for creating a digital asset based smart contract, according to an aspect of the present disclosure. As shown in FIG. 3, the system 300 includes the platform 210 described with reference to FIG. 2 (which may also be referred to as the lending platform 210 as shown in FIG. 3). The lending platform 210 can have one or more market price providers 302-308 connected thereto. In one example, each of the market price providers 302-308 can provide a market value for one or more digital assets such as cryptocurrencies or other assets.

Upon creating a smart contract, including creating and deploying the smart contract on a blockchain network 290, as will be described below, a lending party (e.g., through the user device 230 shown in FIG. 2) transmits capital (loan) 310 secured by digital asset(s) 312 to a borrowing party (e.g., the user device 220 shown in FIG. 2). The capital 312 may be disbursed to the borrowing party through a bank account 314 (e.g. a U.S. bank account) associated with the lending party. Prior to, concurrently with or after the disbursement of the loan 310, the borrowing party pledges digital asset(s) 312 for the disbursed loan 310.

In an example, a digital asset wallet 318 is associated with the lending party while a digital asset wallet 320 is associated with the borrowing party. Accordingly, the pledged digital asset(s) 312 is/are transferred from the digital asset wallet 320 associated with the borrowing party to the digital asset wallet 318 associated with the lending party before, concurrently with or after the disbursement of the capital 310. In an example, a third party wallet provider 322 can facilitate the transfer of digital asset(s) 312 between the digital asset wallets 318 and 320.

In one example, the borrowing party also has a bank account (e.g., a U.S. bank account) 316 associated therewith. The bank accounts 314 and 316 exchange the disbursed capital 310 and monthly payment(s) by the borrowing party for the capital 310 according to the terms of the created smart contract.

Upon completion of the duties/obligations of the lending and the borrowing parties under the created smart contract (successful execution of the terms of the smart contract), the third party wallet provider 322 returns the digital asset(s) 312 that were originally transferred to the digital asset wallet 318 associated with the lending party as collateral for the disbursed capital 310, to the digital asset wallet 320 associated with the borrowing party.

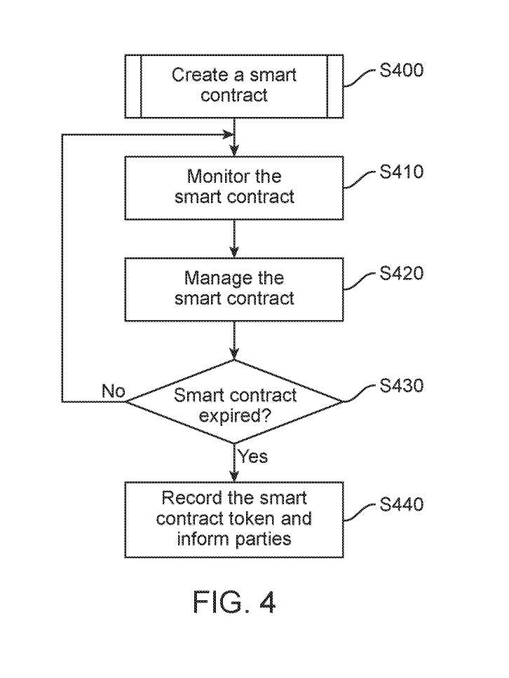

FIG. 4 illustrates a method of creating a digital asset based smart contract, according to an aspect of the present disclosure. FIG. 4 will be described from the perspective of the environment 200 and system/platform 210 of FIG. 2 and/or the system 300 of FIG. 3, on which the smart contract may be created. While FIG. 3 will be described with reference to the system/platform 210, blockchain network 290 and the oracle 250. One or more processors included in the system 210 and/or the blockchain network 290 can execute computer-readable instructions to carry out the underlying functionalities.

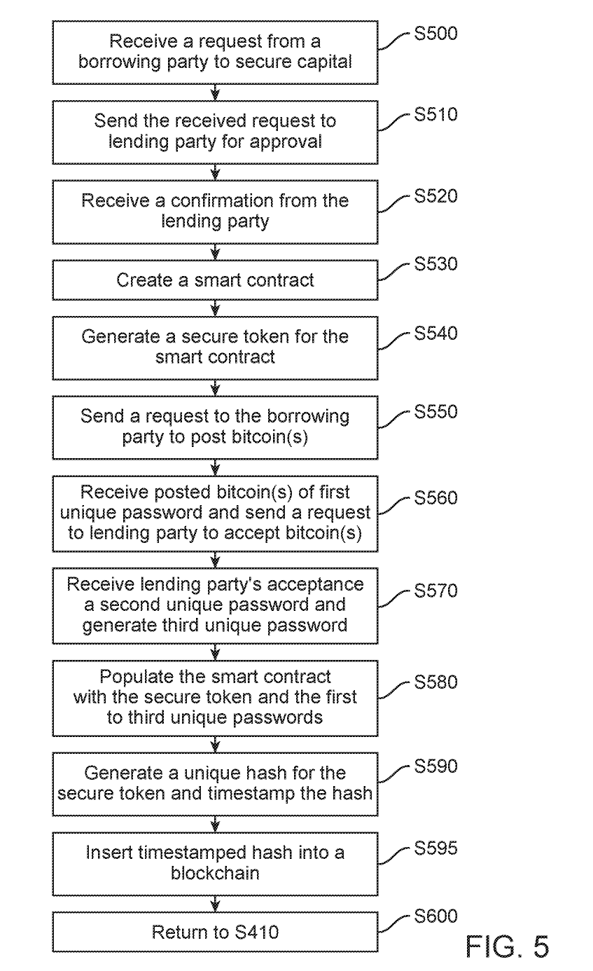

At S400, the system 210 creates a smart contract documenting a contractual relationship of at least two parties based on an exchange of at least one asset. As described above, the contractual relationship is one in which one of the at least two parties (a borrowing party associated with the user device 220) agrees to one or more terms specified by another party (a lending party associated with the user device 230) and provides at least one type of asset (e.g., one or more bitcoins, ETH, real estate, stocks, bonds, home, car, etc.) as collateral in order to receive a loan or a line of credit from the lending party. The system 210 deploys the smart contract onto the blockchain network 290 for execution. The creation of the smart contract will be further described with reference to FIG. 5. The created smart contract may have one or more terms outlining each party's rights and obligations under the smart contract.

Thereafter, at S410, the system 210 and/or blockchain network 290 monitors the execution of the smart contract. For example, the smart contract may have a plurality of execution stages associated therewith. Examples of such execution stages include, but are not limited to, monthly payments by the borrowing party, periodic disbursements by the lending party, periodic release of the digital asset by the lending party back to the borrowing party upon successful completion of specific/designated payment milestones, reevaluation of an interest rate associated with the loan due to triggering of a specified event, change in the value of the digital asset, etc. In one aspect, an oracle 250 can monitor such events and report triggering events to the system 210. The oracle 250 can access information via the network 240 or from other sources 260, 270, 280.

For example, assume that according to a smart contract, a lending party is to provide $3000 in loans to a borrowing party with a 20% interest in exchange for receiving two bitcoins as collateral. Further assume that according to the terms of the smart contract, the borrower is to make monthly payments (e.g., $100) to the lending party for a period of 36 months (totaling a principle+interest payment of $3600), at the end of which the borrowing party will receive the two bitcoins back (upon a successful and complete payment of the loan and the interest).

Throughout the term of the smart contract, the system 210 and/or blockchain network 290 executing the smart contract constantly monitors the smart contract and upon occurrence of certain triggering events (which can be determined, identified, reported, etc. by the oracle 250), communicates appropriate notifications to devices of one or more parties to the smart contract. For example, each time the borrowing party makes a timely payment, the system 210 and/or the blockchain network 290 generates a message to that effect and transmits the same to the lending and borrowing parties (through their respective device 220 or 230). However, upon a failure of the borrowing party to make a timely payment, the system 210 and/or blockchain network 290 generates an appropriate message reminding the borrowing party to make the $100 payment within a grace period (or any other terms as set forth by the terms of the smart contract). Thus, the contract monitored by the oracle 250 for required activities on behalf of the parties consent notifications with cure for any exceptions. All of these terms are built into the contract. The system 210 and/or blockchain network 290 running the smart contract then sends the message to the borrowing and lending parties. Should the borrowing party fail to meet its obligation within the set grace period, the system 210 and/or blockchain network 290 can send a message to the lending and borrowing parties informing the borrowing party that a modification has been made to at least one term of the smart contract (e.g., a penalty, as set forth in the smart contract, has kicked in which may be an interest rate hike of 0.5%).

In one implementation, at S410, the oracle 250 also monitors the value of a bitcoin (again, or any cryptocurrency or asset), which may change from time to time due to market parameters and conditions. The value of the bitcoin (or any asset) can be reported by the oracle 250. Thereafter, at S420, the system 210 and/or blockchain network 290 manages the smart contract based on the monitoring of the performance of the parties to the smart contract and/or the current value of a bitcoin or any other asset that is being monitored for value. The smart contract is executed by the oracle 250 as a signer for any required actions that do not occur on time between the parties to keep the actual loan synchronized with the original loan terms. Managing the contract can include any steps performed by the smart contract as programmed and based on status data or any data of an event impacting performance of the terms of the smart contract.

Monitoring the execution of the smart contract can include identifying, at each one of a plurality of execution stages of the smart contract, a failure of one of the two parties to fulfill an associated term of the contractual relationship and communicating a notification to the two parties, the notification requesting the one of the two parties to fulfill an associated obligation. The method can also include, upon a failure of the one of the two parties to remedy the failure, modifying the smart contract to provide a remedy to an aggrieved party from among the two parties.

In the example above, if a value of a bitcoin is doubled, the system 210 and/or the blockchain network 290 may generate a message requesting the lending party to return one of the two bitcoins to the borrowing party (since the current value of just one bitcoin is now equal to the combined initial value of the two bitcoins provided as collateral by the borrowing party at the time the smart contract went into effect). The system may also evaluate the rate of change in value of the digital asset such that although it may now be twice its original value, the volatility may cause the system to wait to request the return of one of the two bitcoins to the borrowing party. This could be due to an analysis of the periodic value of the asset and a likelihood that the asset may drop in value soon.

In another example, the system 210 and/or the blockchain network 290 may trigger a modification to one or more terms of the smart contract if the change in the current value of a bitcoin relative to the bitcoin's initial value is less than a first threshold or greater than a second threshold. For example, the first threshold may be a drop of 5% (−5%) in the current value of a bitcoin relative to the bitcoin's initial value at the time the smart contract went into effect. Therefore, once the value of the bitcoin drops by more than 5%, the system 210 and/or the blockchain network 290 triggers a modification to the terms of the smart contract (e.g., adjusts a monthly payment to be made by the borrowing party to accommodate for the depreciation in the value of bitcoin, shorten the repayment period, etc.). In another example, assume that the smart contract is created with 10 parameters (numbered 1-10) which, depending on which parameter is set, causes the smart contract to perform a different task or take a different path. The parameter can be initially set to a value such as 4. As the smart contract executes, data from the oracle 250 or other event can cause the modification of the parameter to be a 7. This can cause a new task to be performed or new path to be taken based on the modification of the parameter within the smart contract.

Moreover, the second threshold may be an increase of 5% (+5%) in the current value of a bitcoin relative to the bitcoin's initial value at the time the smart contract went into effect. Therefore, once the value of a bitcoin increases by more than 5%, the system 210 and/or the blockchain network 290 triggers a modification to at least one term of the smart contract (e.g., provide a longer than originally set period of repayment, lower the interest rate to be paid on the load, etc., to accommodate for the appreciation in the value of a bitcoin). These example operations and any other operations which can be contemplated as within the scope of this disclosure are all examples of the system 210 and/or the blockchain network 290 managing the execution of the smart contract according to its programming. In one example, the system 210 or network 290 can manage the smart contract by sending data to the smart contract or instructing the oracle 250 or other data source to send data to the smart contract. The system 210 or network 290 can choose a path or choose an task to be executed, where such options are available, within the smart contract. In this regard, some of the functions performed by the smart contract deployed in the blockchain network 290 can be managed, selected, or instructed by the system 210.

While various examples of message types and/or modifications to one or more terms of the smart contract are described above, the present disclosure and the inventive concepts are not limited thereto. Accordingly, any combination of above example message types and modifications or any other type of known or to be developed message type and modification, as agreed to by the terms of the underlying smart contract, can be used. Furthermore, included herein is the concept of performing an analysis of the value history of the digital asset to determine whether a change to the terms of the smart contract is justified or whether the terms should stay the same such that the likelihood of a reversal of the value will soon occur. The evaluation of the pricing could also take into account other world events such as wars, weather events, or other news that can impact the value of the digital asset. Thus, the analysis of the value of the digital asset could take a number of different parameters into account before making a decision to change the terms or act on a programmed instruction within the smart contract.

At S430, the system 210 determines whether the smart contract has expired. The system 210 determines that the contract has expired if the smart contract has an expiration date associated therewith and/or when all parties have completed/fulfilled their obligations under the smart contract.

If at S430, the system 210 determines that the smart contract has not expired, the process reverts back to S410 and the system 210 repeats S410 to S430. However, if at S430, the system 210 determines that the smart contract has expired, then at S440, the system 210 permanently records the smart contract token (which will be described below) and informs the lending and borrowing parties accordingly.

FIG. 5 illustrates a process of creating a smart contract of FIG. 3, according to an aspect of the disclosure. Generally and prior to creation of a smart contract, lending parties may advertise available capital resource (loans and lines of credit) to interested borrowing parties through the system 210. There may be one or more terms associated with each available source of capital. A borrowing party may log into the system 210 and browse a list of available capital sources and select one or more of the available resources by accepting the term(s) associated with each available capital resource. Alternatively, a borrowing party may advertise on the system 210, the borrowing party's desire to secure a loan or a line of credit. Additionally, the borrowing party may advertise a set of terms and conditions associated with the borrowing party's desire to secure a loan or a line of credit. Accordingly, a lending party may log into the system 210, browse the available requests posted by one or more borrowing parties and select one or more to engage with by accepting the associated advertised terms.

At S500, the system 210 receives a request from the borrowing party (e.g., through an interface provided on the device 220 associated with the borrowing party). The request may be a request to secure a loan or a line of credit in exchange for providing an asset, such as a digital asset or non-digital asset, as collateral. The request may be accompanied by the borrowing party's acceptance of one or more terms associated with a specific loan, as advertised by a lending party.

At S510, the system 210 sends the received request of the borrowing party to the lending party for approval. The system 210 may display a message on the lending party's user device 230 to request an approval of the borrowing party. At S520, the system 210 receives a confirmation from the lending party.

As described above, in one example the roles of the borrowing party and the lending party on the system 210 may switch in that the borrowing party may advertise its desire to secure a loan (accompanied by one or more terms/conditions) and a lending party may select the borrowing party to lend to. Accordingly, S500, S510 and S520 in such case would reverse in a sense that at S500, the system 210 receives a request from the lending party to accept a borrowing party's request to secure a loan. At S510, the system 210 sends the received to the borrowing party for acceptance and at S520, the system 210 receives a conformation from the borrowing party.

Various algorithms and data analysis terms could also be chosen by the party such that, for example, a value history of the cryptocurrency going back 6 months could be included in determining whether to ask for more or return cryptocurrency according to the terms of the smart contract.

Thereafter, at S530, the system 210 creates a smart contract on a blockchain network 290. In an example, the system 210 populates a generic (empty) smart contract with specific terms, agreed upon by the lending and borrowing parties, to generate a smart contract that is then implemented on the blockchain network 290.

At S540, the system 210 generates a secure token for the smart contract. The system 210 generates the token according to any know or to be developed method of generating tokens as it relates to operation of digital currencies and assets. The token is a string of characters that identifies a proper participant in the process or identifies their digital wallet. A token can be considered a key that enables entries on the blockchain network 290 or to confirm that the party proffering the token has the right to sign the contract, receive funds, distribute funds, or perform some function associated with the smart contract.

At S550, the system 210 sends a request to the borrowing party to post one or more assets to an asset address as collateral (e.g., one or more bitcoins to bitcoin address(s)). Concurrent with the posting of one or more bitcoins, the borrowing party also creates a unique password (first unique password) to the bitcoin address(s). In one aspect, the creation of the loan requires a bitcoin address to be created with three keys mandated to be created by three unique parties, the borrower, the lender, and third party which can be the oracle 250.

At S560, the system 210 receives the posted bitcoin(s) (and the first unique password) and sends a request to the lending party to accept the bitcoin(s) as collateral. Upon acceptance, the lending party also creates another unique password (second unique password) in association with the accepted collateral. At S570, the system 210 receives the lending party's acceptance and the second unique password (the second of three keys). The oracle 250 can be notified to generate its unique password (the third of the three keys). All the confirmed loan agreement details can be embedded into the specific open fields of the smart contract in the assigned token.

At S580, the system 210 populates the smart contract with the secure token created at S540, the first unique password, the second unique password and the third unique password. Accordingly, at S580, the system 210 yields/generates a secure smart contract.

Thereafter, at S590, the system 210 and/or the blockchain network 290 creates a unique hash for the secure smart contract and timestamps the same. The system 210 or network 290 could also generate a timestamp and then hash the timestamp with a hash function to generate a hash code or hash value that is then included within the smart contract. From the hash value, the timestamp data can be retrieved. In a sense this provides a notarization of an original copy of the contract. At S595, the system 210 and/or the blockchain network 290 inserts the timestamped hash into a blockchain such as the bitcoin blockchain. The process of inserting the timestamped hash into the blockchain can occur either by the system 210 or by the blockchain network 290. Thereafter, at S600, the process reverts back to S410 of FIG. 4 and S410 to S440 will be repeated as described above.

In one aspect, the system 210 includes a smart contract creator that is configured to receive the data associated with creating the smart contract. The smart contract creator can be configured to: receive a request from a first party, the request having a parameter associated with a contractual relationship, receive a confirmation from a second party comprising an acceptance of the parameter by the second party and create the smart contract on a blockchain network 290 based on the confirmation, the parameter and the contractual relationship. This can be performed by generated the necessary data for operation of the smart contract and deploying the smart contract on the blockchain network via an instruction. A smart contract monitor can be configured to monitor an execution of the smart contract and a current value of an asset associated with the smart contract to yield a status. The value of the asset can be received by an oracle at the smart contract monitor which can perform its programmed functions based on the received data. A smart contract manager can be configured within the system 210 or the blockchain network 290 to manage the smart contract based on the status. These various components can be computer-implemented and programmed in any programming language that is convenient to carry out the respective instructions.

In one or more examples, one or more smart contracts, as described above, can be transferable for trade (buy sell) in a market between interested parties (trading partners). Furthermore, many different assets classes may be coded to fit the criteria of the smart contract and will be allowed as collateral to lend against. Such assets may include, but is not limited to, private equities, bonds, commodities and stocks. Furthermore, indexed tokens may be created that are a bundle of smart contracts that can also be transferred in pieces or as a whole. In one or more examples, multiple assets can be locked and used as collateral in a smart contract as an indexed loan.

In another example, borrowing and lending parties have a mobile application attached to a credit/debit card hybrid that will enable the lending profile to become a digital asset backed line of credit (secured line of credit).

Additional types of loan contracts and financial instruments may be added to the market place available on the system 210 to interact with as borrowers and lenders. Furthermore, other digital currencies may be provided as options to use as the lending currency.

In another example, the lending platform may forge a foreign exchange market partnership that allows for global borrowing and lending parties to trade and receive the currency of their local economy.

In yet another example, direct plug-ins to other technical and traditional financial instructions such a direct deposit, automatic payment options, dividend paying assets, investment options for unused collateral, spending options for unused collateral, and financial accounting plugins for book keeping and financial planning, may be used.

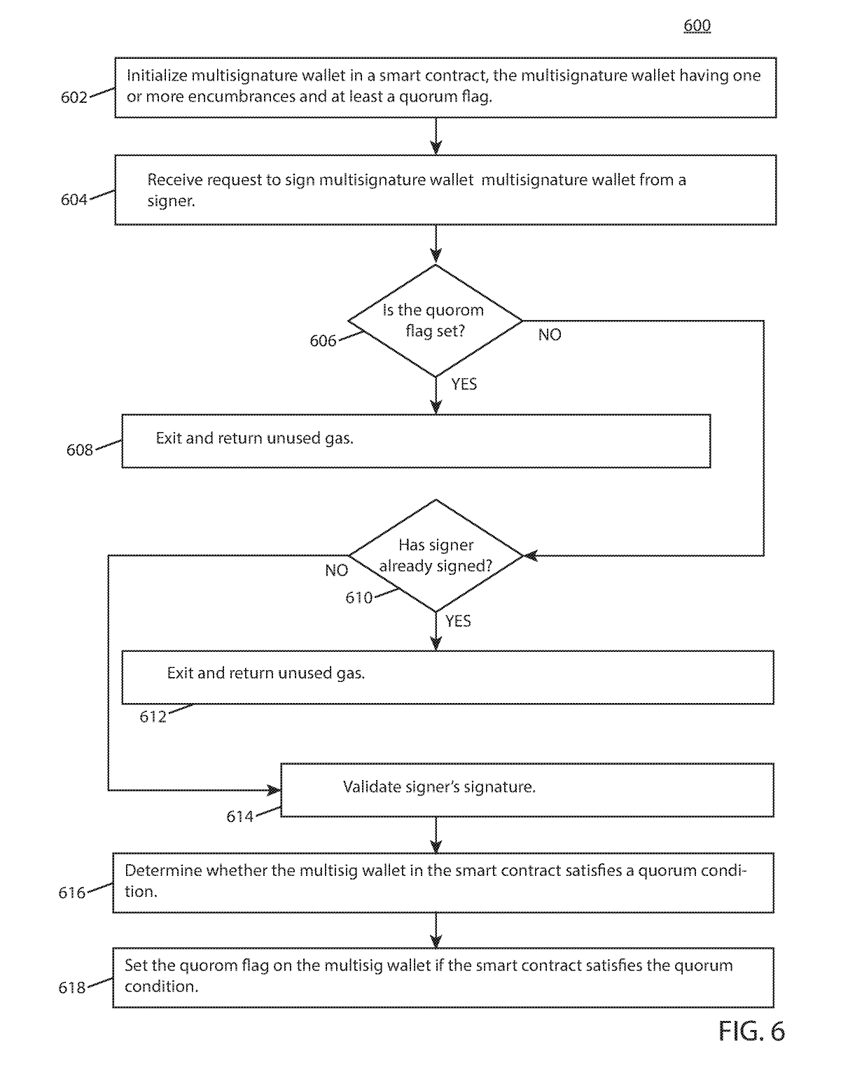

FIG. 6 illustrates a method for implementing a multisignature smart contract. An initializing operation 602 initializes a multisignature wallet in the smart contract, the multisignature wallet having one or more encumbrances and at least a quorum flag. In implementations, the encumbrances may include an n-of-m multisignature requirement, a time-based or block height-based encumbrance, an encumbrance based on an identity of signers, an over-collateralization encumbrance, etc. The initializing operation 602 may be based on a smart contract function called by a network participant (a lender, borrower, oracle, loan manager, etc.). In one implementation, the smart contract for managing a digital asset collateralized loan inherits encumbrances or any other functionality from the multisignature smart contract.

A receiving operation 604 receives a request to sign the multisignature smart contract from a signer. The signer may be, for example, a loan participant (lender, borrower, oracle, loan manager, etc.). In an implementation, the request received in receiving operation 604 is a transaction broadcast to a blockchain network of the multisignature smart contract with a fee. The fee may include a gas price and gas limit for executing the request to sign. The gas limit determines how much computational effort the nodes of the blockchain network will expend before exiting the smart contract. If the gas limit and/or gas price is too low, the request to sign will fail.

Depending on the status of the blockchain network executing the multisignature smart contract, the gas price and gas limit (or equivalent fee) may be quite high. To avoid unnecessarily spending gas, a decision block 606 determines whether a quorum flag is set on the multisignature smart contract. If the quorum flag is set (e.g., if there are already 3 valid signers of a 3-of-4 multisignature contract), then the method 600 exits at operation 608 and returns unused gas to the account on the blockchain network that submitted the request received in operation 604, thus avoiding gas-consuming operations (e.g., on-chain computation, firing of events, etc.).

If the quorum flag is not set at 606, the operations 600 proceed to decision block 610, which determines whether the signer who sent the request to sign the multisignature wallet in operation 604 has already signed the wallet. If the signer has already signed, exit operation 612 exits and returns unused gas to the signer's account on the blockchain network.

If the quorum flag is set at 610, then the operations 600 proceed to validating operation 614 to validate the signature. In an implementation, the signature is “checked” against the address on the blockchain network of the “account” that submitted the request to sign (e.g., the account that called a signing function on the multisignature smart contract and/or a smart contract inheriting therefrom) because the consensus rules of the network only will confirm a transaction if it is correctly signed by the owner of the account.

A determining operation 616 determines whether the multisig wallet in the smart contract satisfies a quorum condition (e.g., if at least n signatures are on an n-of-m multisig wallet). If the quorum condition is satisfied, setting operation 618 sets the quorum flag on the smart contract before exiting execution.

In another aspect, an example method includes initializing a multisignature wallet via a smart contract, the multisignature wallet having at least one encumbrance and/or a quorum flag or parameter. The method includes determining at each signature whether the quorum flag is set (i.e., a quorum is met). If so, the method includes exiting the smart contract and returning unused gas. If a respective signer has already signed the contract, then the method includes existing and returning unused gas. This approach minimizes the amount of gas spent on managing the contract.

If a respective signor's signature is validated, the method can include determining whether a quorum condition is met and if so, setting the quorum flag.

The quorum can be with respect to any event, and not just signatures. For example, if there are 5 triggering events of any type (a signature, oracle-based information, a date, a news event, an encumbrance, etc.) that could occur and if 3 (a quorum) of the 5 occur, then the smart contract should shut down and unused gas returned. The types of parameter could also vary. The set of events could be 1 signature out of 4 plus three non-signature events to trigger the return of gas. The events could be 2 of 4 signatures, an event associated with an encumbrance, and an external event. Machine learning could be employed to evaluate, based on one or more of such events, whether money can be saved by existing the contract and returning unused gas. All interactions and user interfaces could also be included in this disclosure as well. For example, if a threshold is met to query a user or users about whether to exit, but prior to an actual exit, the system could present a query to a user to confirm the exit and thus save gas. Such threshold could be static and set when a smart contract is deployed or could be dynamic and vary throughout the life of the smart contract. The quorum amount or configuration could change based on automatic, detected, or manual intervention.

In another aspect, the amount of unused gas that is returned could vary based on the circumstances. Thus, only a portion of the unused gas could be returned. In some cases, the returned gas could be retrieved again if another parameter is met and it is determine to restart or not fully exit the smart contract.

The concepts disclosed herein can be claimed from any entity within the ecosystem. For example, the concepts could be claimed from the standpoint of the smart contract being created, receiving instructions, and carrying out the functions programmed into the smart contract. Claims could be developed from the standpoint of the platform 210, the oracle 250, the end user device 220 and/or the lender device 230. All of the communications, reporting, confirmations, requests, or exchange of any kind of data or instructions can be included from the standpoint of any one of these entities to carry out the concepts disclosed herein.

An example of the concepts disclosed herein includes a computer-readable storage device. The computer-readable storage device is a man-made physical device such as RAM, ROM, a hard drive, optical drive, or any other device that can store instructions which, when executed by a processor, can cause the processor to perform operations including any one or more of the steps or processes disclosed herein. The computer-readable storage device excludes signals per se and the like.

The present examples are to be considered as illustrative and not restrictive, and the examples is not to be limited to the details given herein, but may be modified within the scope of the appended claims. It is further noted that any feature of any example or any embodiment may be mixed with any other feature disclosed herein. Any method example that includes a series of steps can also include, as one aspect, only one or two of the listed steps. The order of the listed steps may also be modified and performed in any order unless explicitly required.

Claim language reciting “at least one of” a set indicates that one member of the set or multiple members of the set satisfy the claim. For example, claim language reciting “at least one of A and B” means A, B, or A and B.

What is claimed is:

1. A method comprising:
creating, via a processor, a smart contract documenting a contractual relationship of two parties based on an exchange of an asset, the smart contract being implemented on a blockchain network for execution;
monitoring the execution of the smart contract and a current value of the asset to yield a status; and
managing the smart contract based on the status.

2. The method of claim 1, wherein the creating the smart contract further comprises:
receiving a request from a first party, the request comprising a selection of a term associated with the contractual relationship of the two parties;
receiving a confirmation from a second party, the confirmation comprising an acceptance of the term by the second party; and
performing the creating of the smart contract upon receiving an approval from the second party.

3. The method of claim 2, further comprising:
generating a token;
sending a first request to the first party to post the asset, the first party creating a first unique password associated with the asset;
sending a second request to the second party to accept the asset posted by the first party, the second party creating a second unique password upon accepting the asset;
upon receiving an approval of the second request from the second party, generating a third unique password; and
populating the smart contract with the token, the first unique password, the second unique password and the third unique password to yield a secure smart contract.

4. The method of claim 3, wherein:
based on the smart contract, the second party is to provide a loan or a line of credit to the first party in exchange for receiving the asset; and
the asset is a cryptocurrency.

5. The method of claim 4, further comprising:
generating a unique hash for the smart contract; and
marking the unique hash with a timestamp to be placed onto the blockchain network.

6. The method of claim 1, wherein the monitoring of the execution of the smart contract further comprises identifying, at each one of a plurality of execution stages of the smart contract, a failure of one of the two parties to fulfill an associated term of the contractual relationship.

7. The method of claim 6, wherein upon identifying the failure, the method further comprises:
communicating a notification to respective devices associated with each of the two parties, the notification requesting the one of the two parties to fulfill an associated obligation; and
upon a failure of the one of the two parties to remedy the failure, modifying the smart contract to provide a remedy to an aggrieved party from among the two parties.

8. The method of claim 1, further comprising:
determining a change between the current value of the asset and a value of the asset at a time of generating the smart contract.

9. The method of claim 8, wherein the method further comprises:
when the change is greater than a first threshold:
modifying a term of the smart contract related to a first party relative to a second party of the two parties to yield a first modified term, the first party being a recipient of a loan under the smart contract, the second party being a provider of the loan; and
when the change is less than a second threshold:
modifying a term of the smart contract to be more advantageous to the second party compared to the first party to yield a second modified term; and
notifying the two parties of the first modified term or the second modified term.

10. The method of claim 1, wherein the asset is a combination of at least two of:
a digital currency;
a financial product comprising at least one of private equities, bonds, commodities and stocks; and
two or more previously created secure documents associated with one of the two parties.

11. The method of claim 1, wherein managing the smart contract further comprises exiting the smart contract and returning unused gas based on one of an event or a quorum parameter being met.

12. A system comprising:
a processor; and
a computer readable storage medium storing instructions which, when executed by the processor, cause the processor to perform operations comprising:
creating a smart contract documenting a contractual relationship of two parties based on an exchange of an asset, the smart contract being implemented on a blockchain network for execution;
monitoring the execution of the smart contract and a current value of the asset to yield a status; and
managing the smart contract based on the status.

13. The system of claim 12, wherein the computer storage readable medium stores additional instructions which, when executed by the processor, cause the processor to perform operations further comprising creating the smart contract by:
receiving a request from a first party, the request comprising a selection a term associated with the contractual relationship of the two parties;
receiving a confirmation from a second party, the confirmation comprising an acceptance of the term by the second party; and
creating the smart contract upon receiving an approval from the second party.

14. The system of claim 13, wherein the computer readable storage medium stores additional instructions which, when executed by the processor, cause the processor to perform operations comprising:
generating a token;
transmitting a first request to the first party to post the asset, the first party creating a first unique password associated with the asset;
transmitting a second request to the second party to accept the asset posted by the first party, the second party creating a second unique password upon accepting the asset;
upon receiving an approval of the second request from the second party, generating a third unique password; and
populating the token with the smart contract, the first unique password, the second unique password and the third unique password to yield a secure smart contract.

15. The system of claim 14, wherein
based on the smart contract, the second party is to provide a loan or a line of credit to the first party in exchange for receiving the asset, and
the asset is at least one cryptocurrency.

16. The system of claim 15, wherein the computer readable storage medium stores additional instructions which, when executed by the processor, cause the processor to perform operations comprising:
generating a unique hash for the smart contract; and
marking the unique hash with a timestamp to be placed onto the blockchain network.

17. The system of claim 12, wherein the computer readable storage medium stores additional instructions which, when executed by the processor, cause the processor to perform operations comprising:
monitoring the execution of the smart contract by identifying, at each one of a plurality of execution stages of the smart contract, a failure of one of the two parties to fulfill an associated term of the contractual relationship;
communicating a notification to the two parties, the notification requesting the one of the two parties to fulfill an associated obligation; and
upon a failure of the one of the two parties to remedy the failure, modifying the smart contract to provide a remedy to an aggrieved party from among the two parties.

18. The system of claim 12, wherein the computer readable storage medium stores additional instructions which, when executed by the processor, cause the processor to perform operations comprising:
determining a change between a current value of the asset and a value of the asset at a time of generating the smart contract to yield a determined change; and
managing the smart contract by:
modifying a term of the smart contract based on a comparison of the determined change with a first threshold and a second threshold, and
notifying the two parties of the modification to the term.

19. A non-transitory computer-readable medium comprising computer-readable instructions, which when executed by a processor, cause the processor to perform operations comprising:
creating a smart contract documenting a contractual relationship of two parties based on an exchange of an asset;
monitoring an execution of the smart contract and a current value of the asset; and
managing the smart contract based on the monitoring.

20. A system comprising:
a smart contract creator configured to:
receive a request from a first party, the request having a parameter associated with a contractual relationship;
receive a confirmation from a second party comprising an acceptance of the parameter by the second party; and
create a smart contract on a blockchain network based on the confirmation, the parameter and the contractual relationship;
a smart contract monitor configured to monitor an execution of the smart contract and a current value of an asset associated with the smart contract to yield a status; and
a smart contract manager configured to manage the smart contract based on the status.

21. The system of claim 20, wherein the smart contract creator is further configured to:
receive a request from a first party, the request comprising a selection a term associated with the contractual relationship of the first party and the second party;
receive a confirmation from the second party, the confirmation comprising an acceptance of the term by the second party; and
create the smart contract upon receiving an approval from the second party.
